(19) United States
(12) Patent Application Publication
(10) Pub. No.: US 2024/0225358 A1
(43) Pub. Date: Jul. 11, 2024

(54) SERVING STATION FOOD WELL CONDUCTION COLLAR WITH THERMAL BREAK

(71) Applicant: Delfield Company LLC, New Port Richey, FL (US)

(72) Inventors: Nicholas Lee Reihl, Mt. Pleasant, MI (US); Jeremy Robert Huhn, Westphalia, MI (US); Travis James Krchmar, Harrison, MI (US); Thomas Joseph Frick, Shepherd, MI (US)

(73) Assignee: Delfield Company LLC,, New Port Richey, FL (US)

(21) Appl. No.: 18/472,422

(22) Filed: Sep. 22, 2023

Related U.S. Application Data
(60) Provisional application No. 63/437,221, filed on Jan. 5, 2023.

(51) Int. Cl. A47J 39/00; A47J 39/02

(52) U.S. Cl. CPC A47J 39/006; A47J 39/02

(57) ABSTRACT

A food serving station which includes a thermally conductive collar with a thermal break to minimize heat transfer between the side walls of a food well and a metal work top, such that the thermal break minimizes unwanted heat transfer between those two parts and allows more effective and efficient heat transfer from the food wells to the food in the food pans. This heat transfer allows the level of the food in the food pans to be raised to the level of the work top while still maintaining compliance with the NSF temperature requirements and reducing energy use.

### CROSS REFERENCE TO RELATED APPLICATION

The present application claims the benefit under 35 U.S.C. § 119 of U.S. Provisional Patent Application No. 63/437,221, filed on Jan. 5, 2023, the contents of which are incorporated herein by reference.

### BACKGROUND

### 1. Field of the Disclosure

The present disclosure relates to maintaining safe food temperatures in storage pans in food serving stations. More particularly, the present disclosure relates to a food well design for a serving station that more effectively transfers heat to or from the top of the food storage pan, improving temperature control and the consistency of the temperature throughout the food in the pan.

### 2. Description of the Related Art

Prior art food wells are manufactured with the metal walls of the food well positioned directly attached to the metal upper surface of the unit, i.e., the countertop or work top. This results in some of the heat transfer that is provided by the active temperature control system being conducted away from the food well, to the work top, in addition to the food well and pan. Conversely, heat from the ambient environment is thermally conducted from the metal countertop to the top of the food well. The net result is that heating or cooling of the food in the pan (depending on if you're heating or cooling), particularly near the top of the pan, is diminished. Therefore, the upper surface of the food must typically be located significantly below the work top in refrigeration applications to maintain the food temperature within the temperatures required by health and safety regulations, and/or the National Sanitation Foundation (NSF).

This prior art design thus requires that the food in the pan, and/or the pan itself, be located below the most desirable level, i.e., the work top. It also results in the active heating or cooling system using more energy than necessary, by transferring heat to the work top, and potentially, to adjacent food wells held at different temperatures, in addition to the food. This prior art design typically results in the temperature of the food in the pan being inconsistent, with the food at the bottom of the pan being significantly warmer or cooler than the food near the top of the pan. Finally, because prior art food wells are thermally connected to the work top, the areas of the work top adjacent to each well will be heated or cooled like that well. Thus, this can result in the work top being uncomfortably warm or cold in those adjacent areas.

Accordingly, there is a need for a food well design that overcomes the disadvantages described above. In particular, there is a need for a food well design that minimizes heat transfer from the food well to the work top so that the food in the pan can be heated or cooled more effectively, allowing the food in the pan to be located closer to the level of the work top. Moreover, minimizing conduction of heat from the work top to the food well will also reduce the energy needed to heat or cool the food and allow the food to be heated or cooled more consistently from top to bottom. Finally, by minimizing heat transfer between the work top and the food well, it allows the work top to stay at a comfortable temperature while adjacent to all the food wells, regardless if they are heated or cooled.

### SUMMARY

This disclosure provides a food well that is thermally isolated from a work top while maintaining a mechanical connection to the work top.

A serving station of the present disclosure includes a food well configured for receiving a food pan. Further, the serving station includes an active temperature control system for maintaining a required temperature in the food well and the food pan. The food well is designed to more effectively transfer heat from the active temperature control system to the food pan such that the food in the pan can be located closer to the level of the countertop/work top of the serving unit while still maintaining the food at the required temperature. This results in the food being more easily accessible and more visually appealing in the pan.

In one embodiment, the present disclosure provides a thermal break between a food well and a work top which comprises: a vertical wall of a food well disposed on or about a work top; a collar having a thermally conductive material which is connected to the vertical wall; wherein, a horizontal portion of the collar is mechanically or chemically connected to the work top with a thermal break; and wherein, the thermal break comprises a low thermal conductive or non-conductive material.

The collar can transfer heat at least one of to and from a food pan by conduction. The low thermal conductive or non-conductive material can have adhesive properties. The thermal break can be a tape having a low conductivity layer. The low conductivity layer can be a double-sided pressure-sensitive foam tape. Fasteners can also be used to mechanically connect the collar to the work top. Snaps can also be used to mechanically connect the collar to the work top. Fasteners and snaps can also be used to mechanically connect the collar to the work top.

The present disclosure also provides a method for assembling a thermal break, comprising the steps of: disposing a vertical wall of a food well on or about a work top; using a collar having a thermally conductive material which is connected to the vertical wall; connecting, mechanically or chemically, a horizontal portion of the collar to the work top with a thermal break; and wherein, the thermal break comprises a low thermal conductive or non-conductive material.

The method can further comprise the step of using heat transfer energy from a pan or inner liner to, in a conductive manner, refrigerate or heat a ring or collar while isolating the heat transfer energy from the work top.

The above and other objects, features, and advantages of the present disclosure will be apparent and understood by those skilled in the art from the following detailed description, drawings, and accompanying claims. As shown throughout the drawings, like reference numerals designate like or corresponding parts.

### BRIEF DESCRIPTION OF THE DRAWINGS

FIG. 1 is a front perspective view of a food serving station according to the present disclosure.

FIG. 2A is a cross sectional view of a conventional/prior art “flush pan” version of a food well in a food serving station.

FIG. 2B is a close up of the prior art “flush pan” food well of FIG. 2A showing the area where the vertical walls of the food well meet the horizontal work top.

FIG. 3A is a cross sectional view of a conventional/prior art “recessed pan” version of a food well in a food serving station.

FIG. 3B is a close up of the prior art “recessed pan” food well of FIG. 3A showing the area where the vertical walls of the food well meet the horizontal work top.

FIG. 4 is an exploded cross-sectional view of a collar, break, and countertop of the present disclosure.

FIG. 5A is a cross-sectional perspective view of an embodiment of the assembly of the present disclosure.

FIG. 5B is a close-up of the cross-sectional perspective view of FIG. 5A showing the area where the wall of the food well meets the work top.

FIG. 6A is a cross-sectional view of the embodiment of FIG. 5A with a food pan inserted into the food well.

FIG. 6B is a close-up of the cross-sectional view of the embodiment of FIG. 6A showing the area where the wall of the food well meets the work top.

FIG. 6C is a close-up of the cross-sectional view of an alternative embodiment of FIG. 6A showing the area where the wall of the food well meets the work top.

### DETAILED DESCRIPTION OF THE DISCLOSURE

The present disclosure provides a food serving station with a food pan for holding the food, a food well having a collar, and work top. There is a thermal break between the food pan and the work top, to prevent or minimize heat transfer between the two. In the manner described in detail below, the present disclosure uses the heat transfer energy from the food pan to, in a conductive manner, refrigerate or heat the collar while isolating the food pan and collar from the work top. This satisfies regulatory standards and keeps the food pan and/or food level flush with the work surface. In past designs, the creation of down bends in the work top were used to attach the heated or cooled pan to the top. In these cases, the customer's food pan had to be recessed 1.5 inches to meet regulatory standards.

The vertical walls of the food well are attached to the work top using the collar, which is riveted to the vertical walls of the food well. The collar can be made of a thermally conductive material. A horizontal portion of the collar is attached to the work top via a thermal break that can be any low conductive or non-conductive mechanical, chemical or any other method. In one embodiment, the thermal break is a double-sided pressure-sensitive foam tape. The low thermal conductivity of the thermal break is what provides thermal isolation from the work top while maintaining a mechanical connection to the work top. Thus, while there are other ways of creating a thermal break, this method minimizes the need for mechanical fasteners, assembly labor, and does not require any custom parts (e.g., molded plastic parts). Mechanical fasteners such as snaps or rivets may also be used to more securely fasten the collar to the work top and thermal break.

In an alternative embodiment, the food well can have a flange bent into the top of the food well, creating a horizontal wall, replacing the collar. The horizontal wall of the flange can be attached to the work top via a thermal break that can be any low conductive or non-conductive mechanical, chemical or any other method, e.g., a double-sided pressure-sensitive foam tape. Again, the low thermal conductivity of the thermal break is what provides thermal isolation from the work top while maintaining a mechanical connection to the work top. This horizonal flange of the food well would eliminate the need for the collar of the present disclosure.

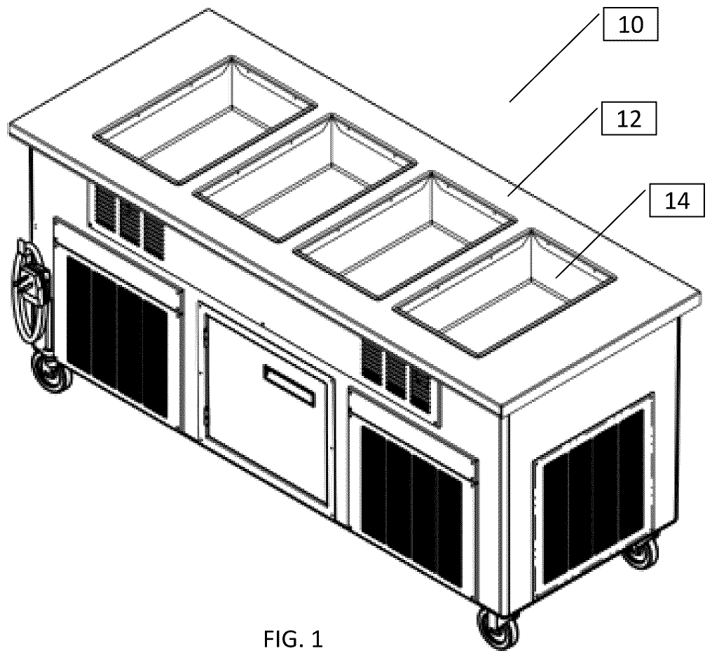

Referring to the drawings, in FIG. 1, a food serving station generally represented by reference numeral 10 (hereinafter “station 10”) is shown, according to the present disclosure. Station 10 has a number of food wells 14 recessed into the work top 12 that are designed to hold and refrigerate and/or heat food pans that hold food for a school, restaurant, buffet line, food preparation station, etc. The purpose of a food serving station is to present various hot and/or cold foods for ready access by customers or workers.

Conventional food wells 14 in food serving stations 10 include both “flush pan” designs where the food pan is meant to sit flush with the work top 12, and “recessed pan” designs where the food pan sits down inside the food well about 0.01 to about 2 inches.

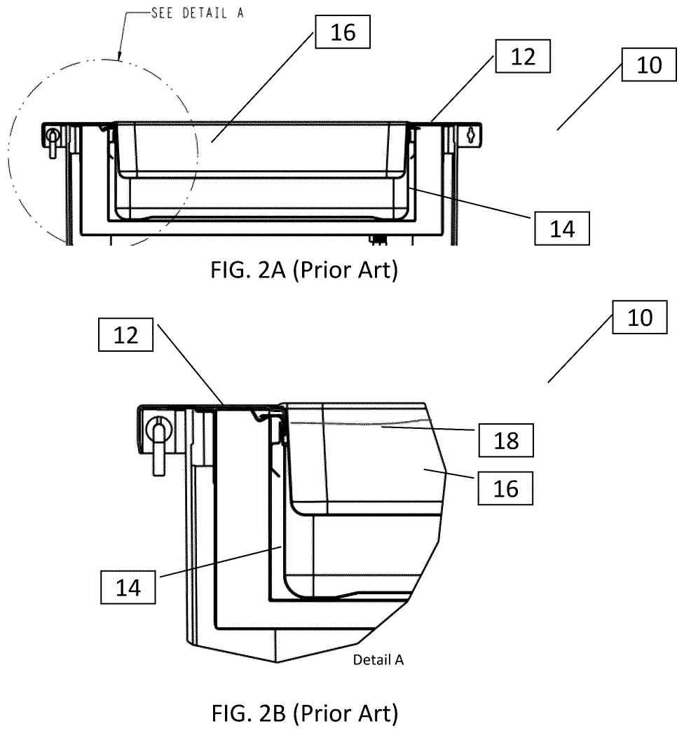

In FIG. 2A, an illustration of the prior art “flush pan” design where the food pan sits flush with the work top is shown, according to the present disclosure. This drawing shows food well 14 with food pan 16 positioned in food well 14. Food pan 16 is 4 inches tall.

In FIG. 2B, a close-up view of the food well 14 in the area labeled “Detail A” in FIG. 2A is shown, according to the present disclosure. FIG. 2B shows the highest food level 18 for the food in food pan 16. This food level 18 (which is approximately ½ inch below the level of work top 12) is the highest food level possible with this prior art design which can achieve the required refrigerated food temperature. When the food well 14 is used for cooling, placing food higher than food level 18 causes the top layer of food to be warmer than what is allowed. Running the refrigeration system colder to allow the food level 18 to be raised is not possible, as it causes the food near the bottom to be colder than what is allowed by health and safety regulations, and/or NSF (primarily because the food at the bottom of the pan can freeze).

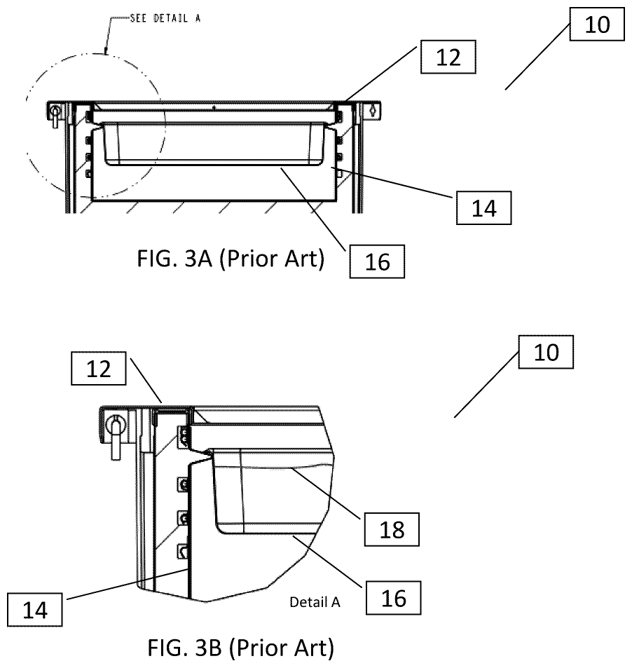

In FIG. 3A, an illustration of the prior art “recessed pan” design where the food pan sits below the level of the work top is shown, according to the present disclosure. This drawing shows food well 14 with food pan 16 positioned in food well 14. Food pan 16 is 4 inches tall.

In FIG. 3B, a close-up view of the food well 14 in the area labeled “Detail A” in FIG. 3A is shown, according to the present disclosure. FIG. 3B shows the highest food level 18 for the food in food pan 16. This food level 18 is the highest food level possible with this prior art recessed pan design which can achieve the required refrigerated food temperature. As stated above, a higher food level is not possible without either causing the food to be too warm on top or too cold on the bottom of the pan.

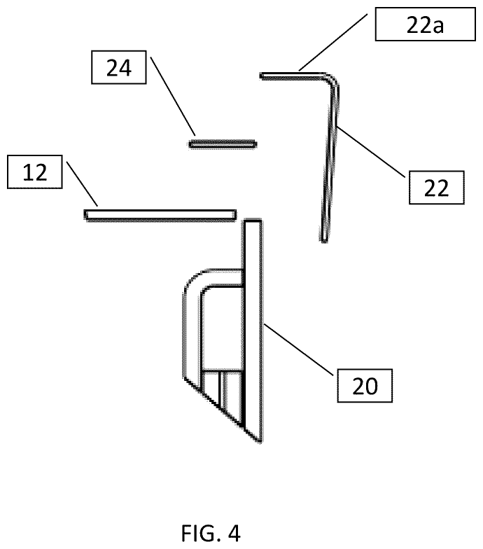

The key to improving heat transfer between the refrigerated walls of the food well 14, the food pan 16, and the food itself, is to create a thermal break between the work top 12 and the food well 14. This minimizes the undesirable heat transfer between the work top 12 and the food well 14. The way to create this thermal break according to the present disclosure is illustrated in FIG. 4.

In FIG. 4, an exploded cross-sectional view of the area where the vertical walls 20 of food well 14 meet the horizontal work top 12 is shown, according to the present disclosure. The vertical walls 20 of food well 14 are attached to work top 12 using a collar 22 which is riveted to vertical walls 20 of food well 14. A horizontal portion 22a of collar 22 is connected to and in one embodiment on top of work top 12 via thermal break 24. As previously discussed, in one embodiment thermal break 24 is double-sided pressure-sensitive foam tape. The low thermal conductivity of thermal break 24 is what provides thermal isolation between food well 14, collar 22, and work top 12. While there are other ways of creating a thermal break, this method minimizes the need for mechanical fasteners, assembly labor, and does not require any custom parts (molded plastic parts, for example). Other possible means for creating a thermal break 24 between the work top 12 and the vertical walls 20 of food well 14 include, for example, having a silicone, plastic or other minimally conductive or non-conductive layer, which may have adhesive properties, and substituting it for foam tape 24.

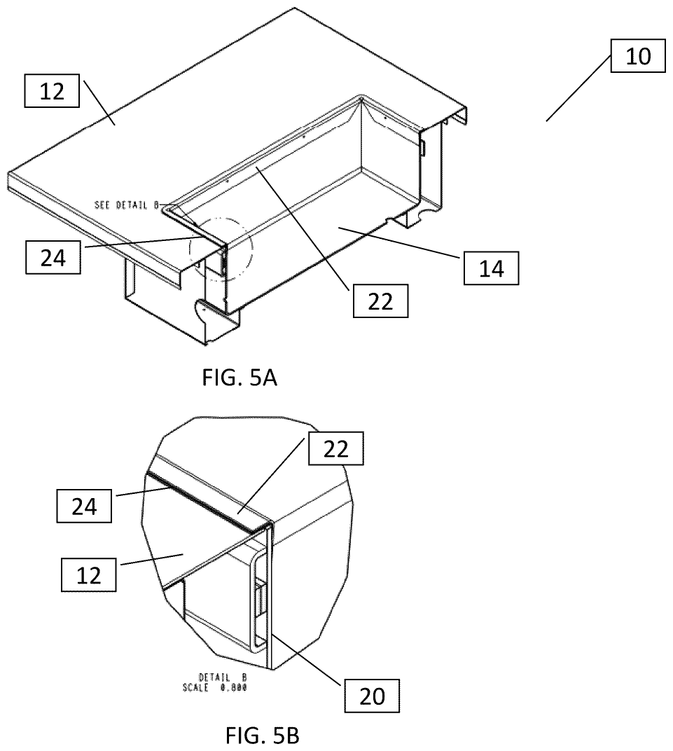

In FIGS. 5A and 5B, perspective views of the assembled station 10 with food well 14 and work top 12 are shown, according to the present disclosure. These figures again show collar 22 and thermal break 24.

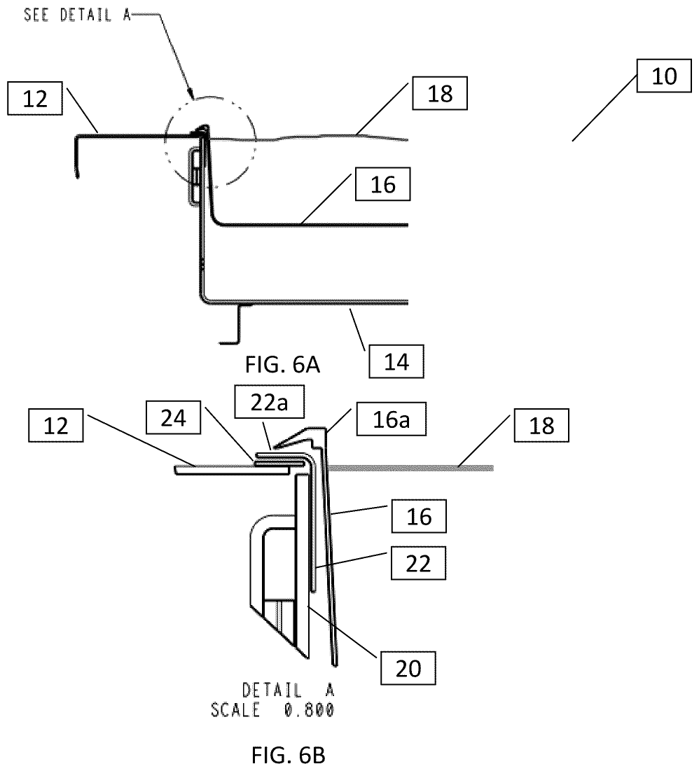

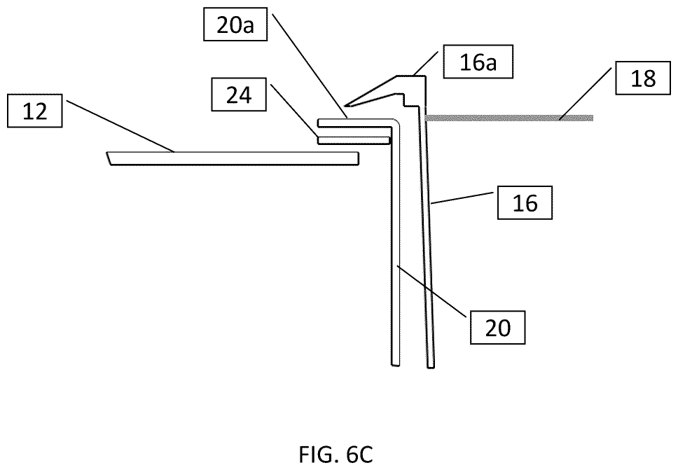

In FIGS. 6A, 6B and 6C, a cross-sectional view illustrating the food level 18 that is possible with the new configuration is shown, according to the present disclosure. As shown in this drawing, with a thermal break 24 between the vertical wall 20 of food well 14 and work top 12, it is possible to raise the food level 18 to be even with the work top 12 and still achieve all regulatory food temperature requirements. The surface of food (food level 18) will stay below the maximum temperature allowed by regulatory agency requirements, while the temperature of the food in the bottom of the food pan 16 will stay above the minimum allowed.

As shown in FIG. 6B, in particular, food pan 16 can have a horizontal flange 16a. During operation of station 10, food is stored within pan 16. Pan 16 is within food well 14. Flange 16a. horizontal portion 22a of collar 22, and thermal break 24 are in vertical stacked arrangement and thermal break 24 contacts work top 12. Thus, there is minimal or no heat transfer between work top 12 and food well 14 or food pan 16, since thermal break 24 is minimally conductive or entirely non-conductive. Food well 14 can be cooled or heated according to methods such as an ice bath, heat bath, other fluid media (e.g., glycol), or air conditioning. Since collar 22 is conductive and in contact with well 14, whatever heating or cooling is applied to well 14 will also heat or cool collar 22, which in turn will cool or heat pan 16 and the food contents therein. The described arrangement, i.e., where there is a mechanical but thermally isolated connection between food pan 16 and work top 12, allows for the maintenance of food within pan 16 at a desired temperature, while allowing food to be placed at a food level 18 that is suitable for users. Pan 16 can also sit within and be connected to well 14 through other methods than flange 16a.

As shown in FIG. 6C, in particular, food well 14 can have a horizontal flange 20a. During operation of station 10, food is stored within pan 16. Pan 16 is within food well 14. Flange 16a, horizontal flange 20a of vertical wall 20, and thermal break 24 are in vertical stacked arrangement and thermal break 24 contacts work top 12. Thus, there is minimal or no heat transfer between work top 12 and food well 14 or food pan 16, since thermal break 24 is minimally conductive or entirely non-conductive. Food well 14 can be cooled or heated according to methods such as an ice bath, heat bath, other fluid media (e.g., glycol), or air conditioning. Since horizontal flange 20a of vertical wall 20 is conductive and is part of and extends horizontally from the periphery of well 14, whatever heating or cooling is applied to well 14 will also heat or cool horizontal flange 20a of vertical wall 20, which in turn will cool or heat pan 16 and the food contents therein. The described arrangement, i.e., where there is a mechanical but thermally isolated connection between food pan 16 and work top 12, allows for the maintenance of food within pan 16 at a desired temperature, while allowing food to be placed at a food level 18 that is suitable for users. The embodiment of FIG. 6C thus eliminates the need for collar 22 of prior embodiments. Pan 16 can also sit within and be connected to well 14 through other methods than flange 16a.

The techniques described herein are exemplary and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. A station for storing food, comprising:
a work top having a horizontal surface;
a food well in the work top, wherein the food well has a vertical wall;
a collar connected to the vertical wall, wherein the collar has a horizontal flange; and
a thermal break;
wherein the horizontal flange of the collar is mechanically or chemically connected to said work top via the thermal break, and
wherein, the thermal break comprises a low thermal conductive or non-conductive material.

2. The station of claim 1, wherein the collar comprises a thermally conductive material.

3. The station of claim 1, further comprising a food pan within the food well.

4. The station of claim 3, wherein the collar transfers heat at least one of to and from the food pan by conduction.

5. The station of claim 1, wherein the thermal break has adhesive properties.

6. The station of claim 1, wherein the thermal break is a tape having a low conductivity layer.

7. The station of claim 6, wherein the low conductivity layer is a double-sided pressure-sensitive foam tape.

8. The station of claim 1, further comprising a mechanical fastener, wherein the mechanical fastener mechanically connects the collar to the work top.

9. The station of claim 1, further comprising a snap, wherein the snap mechanically connects the collar to the work top.

10. The station of claim 1, wherein the horizontal flange of the collar and the thermal break are in stacked vertical alignment on the work top.

11. The station of claim 3, wherein the food pan has a horizontal flange.

12. The station of claim 11, wherein the horizontal flange of the food pan, the horizontal flange of the collar, and the thermal break are in stacked vertical arrangement on the work top.

13. A method for assembling a station for storing food products, the method comprising the steps of:
connecting a collar to a vertical wall of a food well, wherein the collar has a horizontal flange;
placing the vertical wall of a food well on a horizontal work top; and
connecting, mechanically or chemically, the horizontal flange of the collar to the work top via a thermal break,
wherein the thermal break comprises a low thermal conductive or non-conductive material.

14. The method of claim 13, wherein the collar transfers heat at least one of to and from the food pan by conduction.

15. The method of claim 13, wherein the thermal break has adhesive properties.

16. The method of claim 13, wherein the thermal break is a tape having a low conductivity layer.

17. The method of claim 16, wherein the low conductivity layer is a double-sided pressure-sensitive foam tape.

18. The method of claim 16, further comprising the step of connecting the food well to the work top with the low conductivity layer and fasteners.

19. The method of claim 16, further comprising the step of connecting the food well to the work top with the low conductivity layer and snaps.

20. The method of claim 13, further comprising using heat transfer energy from a pan or inner liner to, in a conductive manner, refrigerate or heat a ring or collar while isolating the heat transfer energy from said work top.

21. A station for storing food, comprising:
a work top having a horizontal surface;
a food well in the work top, wherein the food well has a vertical wall;
a flange bent into the top of the vertical wall of the food well, wherein the flange has a horizontal wall; and
a thermal break;
wherein the horizontal wall of the flange is mechanically or chemically connected to said work top via the thermal break, and
wherein, the thermal break comprises a low thermal conductive or non-conductive material.
